(19) United States
(12) Patent Application Publication
(10) Pub. No.: US 2015/0372842 A1
(43) Pub. Date: Dec. 24, 2015

(54) SYSTEMS AND METHODS FOR IMPROVED WIRELESS CHANNEL ESTIMATION

(71) Applicant: Ixia, Calabasas, CA (US)

(72) Inventors: David Jennings Wicker, JR., Hillsboro, OR (US); Thomas Alexander, Mulino, OR (US)

(21) Appl. No.: 14/308,680

(22) Filed: Jun. 18, 2014

(51) Int. Cl. H04L 25/02; H04B 7/04

(52) U.S. Cl. CPC H04L 25/0242; H04B 7/0456

(57) ABSTRACT

Systems and methods are disclosed herein to provide improved channel estimation in a wireless data communication system, including but not limited to Multiple Input Multiple Output (MIMO) communication systems. In accordance with one or more embodiments and aspects thereof, a channel estimation system is disclosed that utilizes data payload portions of received wireless packets to calculate estimates of the radio frequency (RF) channel traversed by these packets, and iteratively refines and improves these estimates by selectively utilizing successive received packets according to the application of certain metrics. Such a system may offer improved capabilities such as: more accurate signal reception, reduced bit error ratio, and better reception of short data packets.

### RELATED APPLICATIONS

This application is related to co-pending U.S. patent application Ser. No. 61/900,973 entitled “SYSTEMS AND METHODS FOR IMPROVED WIRELESS CHANNEL ESTIMATION” filed on Nov. 6, 2013, the disclosure of which is incorporated herein by reference in its entirety.

### TECHNICAL FIELD

The subject matter described herein relates generally to wireless data communication systems, and particularly to systems and methods for estimating the properties of radio frequency (RF) wireless channels that may exist between an RF transmitter and receiver. More particularly it relates to determining and using the properties of RF channels for compensation, equalization and data recovery purposes, including but not limited to multiple-input multiple-output data communications.

### BACKGROUND

Modern wireless data communications systems may utilize the benefits of multiple transmit and receive antennas to improve both range and data communications bandwidth. In particular, Multiple Input Multiple Output (MIMO) systems can utilize the spatio-temporal properties of the RF channel to transmit parallel but independent streams of data, greatly increasing the amount of data that can be transferred from a transmitter to a receiver. MIMO systems are therefore seeing widespread use in high-speed wireless digital transmission systems.

MIMO systems take advantage of the fact that radio frequency (RF) environments may contain large numbers of reflective and diffractive objects, the effect of which is to impose multiple propagation modes on the RF channel existing between a transmitter and a receiver. The number of available propagation modes is determined by the number of antennas at the transmitter and receiver. Each individual propagation mode may convey an independent, uncorrelated RF signal, which may then be distinguished, identified and extracted at the receiver. A MIMO transmitter may therefore split a single stream of digital data into independent parallel streams and transmit each stream on a different propagation mode as a separate RF signal. Given an adequate number of receive antennas, and knowledge of the channel propagation modes, a MIMO receiver may separate and decode the parallel streams of data and may combine them to regenerate the original stream of digital data. The capacity of a MIMO system is therefore a multiple of the capacity of a conventional Single Input Single Output (SISO) system operating over the same RF channel.

A MIMO RF wireless channel with N transmit and M receive antennas may be represented as an N×M complex matrix, referred to as a H or channel matrix, with each matrix coefficient representing the transfer function between an individual pair of transmit and receive antennas. As the number of available propagation modes is the lesser of the number of transmit and receive antennas, it may be usual to set N=M for an equal number of antennas on both sides, making the maximum number of parallel data streams that may be transmitted equal to N.

An exemplary MIMO RF wireless communication system may contain a transmitter that may accept a stream of digital transmit data which may then be split into parallel streams, processed using a space-time coding method, modulated, and eventually transformed to RF signals that may be transmitted on the N transmit antennas. These signals may then traverse the RF channel represented by the channel matrix, and then may arrive at the N receive antennas of a MIMO receiver. The receiver may then convert and process these signals, and may further use a MIMO equalizer to remove the effects of the channel matrix upon the transmitted signals and may recover the original space-time coded signal. The equalized signal may then be passed to a demodulator and MIMO decoder which may invert the space-time coding to regain the separate streams of data signals, which may then be reconstituted back into the original digital transmit data.

It is apparent that a MIMO equalizer in a wireless receiver may play a key role in reception by compensating for the effects of the RF channel and allowing the extraction of individual signal streams that may have been impressed into the various propagation modes of the channel matrix. As the equalization coefficients utilized by the MIMO equalizer may be dependent on the channel matrix, which may vary significantly by physical location and time, the coefficients of the channel matrix may have to be accurately estimated at the receiver in order to receive the data. This process is known as channel estimation. Once these channel estimates have been determined, they may be used in turn to calculate the coefficients used by the MIMO equalizer. A poor channel estimate may make it difficult or impossible to correctly separate the data streams, leading to a much higher error rate for the recovered data streams at the same signal level. Therefore, accurate channel estimation may be extremely important for MIMO systems.

Estimation of the channel matrix may be accomplished by using special known training sequences (e.g., preamble sequences or pilot signals), which may be extracted from the transmitted signal, which may for instance be an IEEE 802.11 Wireless Local Area Network (WLAN) packet stream or a 3GPP Long Term Evolution (LTE) frame stream. For example, the MIMO reception function may first determine the value of the channel matrix H using known symbols in preamble and/or pilot signals transmitted by the MIMO transmitter, and may use these to calculate the complex equalization matrix that may then be used to recover the payload. However, the number of these training sequences or pilots may be relatively small compared to the data signals, which may adversely affect the accuracy of channel estimation. As an alternative, channel estimation may be accomplished under certain conditions using the actual packet data payload itself, which may greatly increase the amount of signals available for improving the quality of the estimates. Various approaches to achieve this are discussed in co-pending U.S. patent application Ser. No. 61/900,973, herein incorporated by reference. As such, it is assumed that the details of different methods of generating a channel estimate, or the coefficients of a channel equalization matrix, or both, are available to a person skilled in the art and need not be discussed further herein. It should also be understood that channel estimation may directly comprise the calculation of the equalization matrix, omitting the calculation of the intermediate H matrix as it may not be strictly necessary for wireless reception.

Different methods of calculating the equalization matrix are known, which may range from simple zero-forcing to more complex systems such as sphere decoding. However, due to distortion in the RF transmitter and noise in the RF channel (as well as signal noise in both RF transmitter and receiver), it may not be possible to exactly calculate the channel matrix H or the equivalent equalization matrix. Unfortunately, inaccuracies in the calculations may increase the probability of errors in the decoded receive data. It may therefore be essential to make the channel estimates as accurate as possible in the face of noise and distortion.

These errors and variations may particularly impact higher-order modulations, such as Orthogonal Frequency Division Multiplexing (OFDM) with 64 and 256 Quadrature Amplitude Modulation (QAM) modulations; higher bandwidth transmissions (such as 80 MHz and 160 MHz channel bandwidths) where the channel may not be frequency-flat over its entire range; and may also adversely affect larger packet sizes where the ratio of training signals to data signals is lower. This may make the system more susceptible to inaccuracies in the estimated channel. Another significant issue is that the channel characteristics and therefore the channel estimate may become inaccurate over time due to changing propagation conditions: for example, if the MIMO transmitter and receiver move with respect to each other, or if the RF propagation environment itself changes. This may induce errors in the decoded receive data stream, as the equalization matrix coefficients may no longer be accurate.

As noted in the above-referenced co-pending U.S. patent application, a possible method of reducing the impact of noise and distortion is to use the training fields in the preamble to derive an initial channel estimate and then use the information in the data payload of the packet to refine the estimate. However, this may be primarily applicable to long data packets, as short data packets may not contain enough data symbols to produce a usable channel estimate from the random bit patterns present in the payload. Another possible method, also noted in the above-referenced co-pending application, is to increase accuracy by averaging channel estimates over multiple successive packets. However, this approach may require that the channel be largely invariant over time, and may also require some method of distinguishing between packets from different sources that are received over different RF channels. Again, this latter approach may be principally applicable to long data packets, as the time required to determine where the packet is coming from and the approximate nature of the RF channel may be too long to enable it to be applied to short packets.

In general, if the average packet data payload length is long, then it may be possible to generate a good channel estimate from a few consecutive packets. For a short average payload length, however, a large number of closely spaced packets may need to be processed to obtain a reasonably accurate channel estimate. Thus the initial data packets in a burst of data do not benefit from techniques to improve channel estimation, unless they are buffered for later processing. However, buffering may incur significant latency, which may not be tolerated in the system. Alternative techniques to accumulate channel estimates over a number of short packets may suffer from the issue that it is difficult to determine when the channel has actually changed and the estimates need to be recalculated from scratch. Further, the rapid storage, lookup, matching and retrieval of channel estimates for a large number of RF sources transmitting short packets to a single receiver at high rates may be computationally prohibitive.

It may be apparent from the foregoing discussion that accurate and efficient channel estimation is important for high-bandwidth wireless communication. It may further be apparent that more advanced technologies such as OFDM and MIMO may greatly increase the need for accurate and reliable channel estimation and equalization. However, the initial channel estimates that may be obtained from the short training sequences embedded in the preamble may not be adequate, and averaging estimates over a number of short frames may become inaccurate if the channel changes substantially over time.

There is hence a need for improved MIMO wireless channel estimation and equalization systems and methods. A system that can quickly identify when a stored channel estimate is usable for an incoming packet may be desirable. Further, it may be preferred in such a system to be able to achieve this with little computational overhead, for example to allow its implementation using existing hardware technologies. Such a system may preferably be applicable to communications involving long bursts of short frames received from multiple different wireless transmitters. Finally, it may be desirable for such a system to detect and adapt to changing RF channel conditions.

### SUMMARY

Systems and methods are disclosed herein that may provide improved techniques for channel estimation and equalization in wireless data communication devices and systems. Such techniques may enable the improved generation of more accurate and reliable channel estimates and corresponding equalization matrices, and further may detect changing channel conditions and allow these channel estimates and equalization matrices to be updated and modified to accommodate them. The systems and methods disclosed may further improve the accuracy of generated channel estimates and equalization matrices for bursts of short wireless data packets, and may also allow these channel estimates and equalization matrices to be improved when receiving data from multiple transmitting devices concurrently.

In accordance with one embodiment, a MIMO wireless receiver datapath is disclosed that may enable channel estimates to be generated from multiple successive received data packets. The wireless receiver datapath may contain: receive RF processing functions; Analog-to-Digital (A/D) and baseband processing functions; MIMO equalization processing functions; demodulation and MIMO decoding functions; MIMO channel estimation functions; metric calculation functions for calculating various metrics related to the channel estimates; channel estimate memory for holding one or more channel estimates and associated metrics; and channel estimate processing functions to calculate improved channel estimates and equalization coefficients, provide them to the MIMO equalizer, and store them in the channel estimate memory.

Preferably, the MIMO equalization processing functions may be provided with an improved set of equalization coefficients from the channel estimate processing functions by combining newly calculated channel estimates and previously calculated and stored channel estimates. These improved equalization coefficients may be processed to ensure that channel changes are detected and prevented from impairing the accuracy of these estimates. Further, these improved equalization coefficients may be saved for later use.

Advantageously, improved channel estimates may be stored in a channel estimate memory for each transmitter that may be sending wireless data packets to this MIMO wireless receiver, and these channel estimates may be selectively retrieved for use with future received data from that transmitter.

Advantageously, the channel estimate improvement may be performed using a weighted average function that may be selected to reduce the impairment of distortion and noise.

Advantageously, a channel change metric may be calculated and used to determine whether the RF properties of the channel have deviated substantially from the previously known RF properties, which may in turn be used to control the calculation and update of the new channel estimate. This channel change metric may be used to select a between multiple previously stored channel estimates, representing the properties of multiple RF channels traversed by the signals from multiple wireless transmitters.

Advantageously, an identifying metric may be calculated and used to reduce the number of stored channel estimates that must be searched before applying the channel change metric.

Advantageously, the identifying metric may further be used to order the selected stored channel estimates before searching, thereby speeding up the search.

The subject matter described herein may be implemented in software in combination with hardware and/or firmware. For example, the subject matter described herein may be implemented in software executed by a processor. In one exemplary implementation, the subject matter described herein may be implemented using a computer readable medium having stored thereon computer executable instructions that when executed by the processor of a computer control the computer to perform steps. Exemplary computer readable media suitable for implementing the subject matter described herein include non-transitory devices, such as disk memory devices, chip memory devices, programmable logic devices, and application specific integrated circuits. In addition, a computer readable medium that implements the subject matter described herein may be located on a single device or computing platform or may be distributed across multiple devices or computing platforms.

### BRIEF DESCRIPTION OF THE DRAWINGS

The detailed description herein of the features and embodiments are best understood when taken in conjunction with the accompanying drawings, wherein:

FIG. 1 shows a simplified representation of a MIMO wireless communications system involving a single transmitter sending information to a single receiver over a single RF channel;

FIG. 2 depicts a MIMO wireless communications system with multiple transmitters sending information to a single receiver along multiple RF channels;

FIG. 3 is a conceptual representation of a wireless receiver storing multiple channel estimates looked up with identifying metrics according to an embodiment of the subject matter described herein;

FIG. 4 represents an exemplary block diagram of a system that may perform equalization using a weighted average of initial and stored channel estimates according to an embodiment of the subject matter described herein; and

FIG. 5 is an illustrative flow chart of the channel estimation and equalization process according to an embodiment of the subject matter described herein.

It should be understood that like reference numerals are used to identify like elements illustrated in one or more of the above drawings.

### DETAILED DESCRIPTION

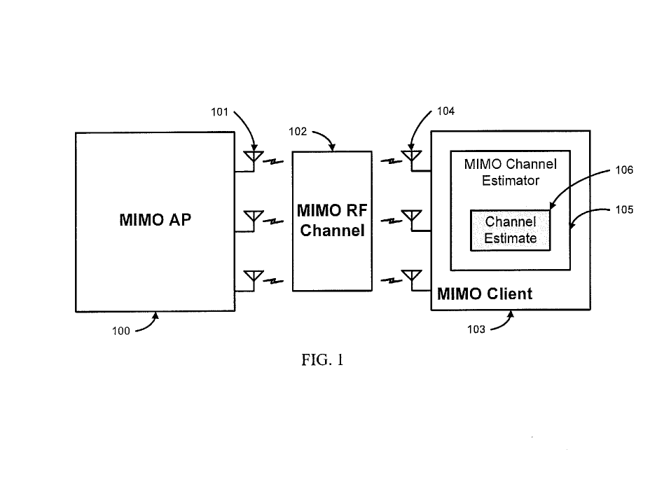

FIG. 1 depicts a block level representation of an exemplary MIMO wireless transmission system that may comprise MIMO Access Point (AP) 100 transmitting digital signals via antennas 101 through MIMO RF channel 102 to MIMO client 103. Such an exemplary system may be used for instance in IEEE 802.11 wireless Local Area Networks (LANs). Client 103 receives the transmitted signals via its antennas 104. RF channel 102 may contain multiple propagation modes by virtue of the presence of RF reflection and interference/diffraction effects. The multiple transmit antennas 101 may enable transmitting AP 100 to send independent data streams carried on independent RF signals introduced into independent propagation modes of RF channel 102, which are then received by multiple receive antennas 104.

In order to calculate and compensate for the effects of RF channel 102 (effectively, to ascertain the various propagation modes of the channel and reverse the effects of the RF channel on the transmitted independent RF signals), client 103 may contain a MIMO channel estimator 105. Channel estimator 105 may accept the signals from multiple antennas 104, use known or estimated data values to estimate the coefficients of channel matrix representing RF channel 102, further calculate a channel equalization matrix accordingly, and may provide this equalization matrix to the remainder of the MIMO receive functions in client 103. The equalization matrix may then be used by client 103 to eliminate the effects of RF channel 102 and recover the original transmitted RF signals. Thereafter by the usual process of decoding and demodulation, client 103 may recover and reconstitute the original transmitted data stream.

It is understood that while FIG. 1 depicts three sets of transmit antennas 101 and three sets of receive antennas 104 (which may be equivalent to a MIMO channel containing at most three independent propagation modes), this is represented purely for illustrative purposes and an embodiment may utilize any desired number of transmit antennas 101 and receive antennas 104. The maximum number of independent propagation modes and therefore the maximum number of parallel data streams is limited by the minimum of the number of transmit antennas 101 and receive antennas 104.

A memory within channel estimator 105 may be used to store the channel estimate calculated by client 103, indicated as channel estimate 106. Stored data 106 may be either the actual channel estimate (i.e., the H matrix of RF channel 102), the channel equalization matrix (i.e., the matrix required to reverse the effects of RF channel 102), both matrices, or some related matrix thereof. Stored data 106 may be used for either comparison or for signal recovery purposes, or both. For instance, co-pending patent application Ser. No. 61/900,973 may illustrate a method whereby a channel estimate may be computed from a previous packet, stored for example as data 106, and then may be utilized to improve the channel estimate for a subsequent packet, possibly with the aid of higher-layer protocol interactions.

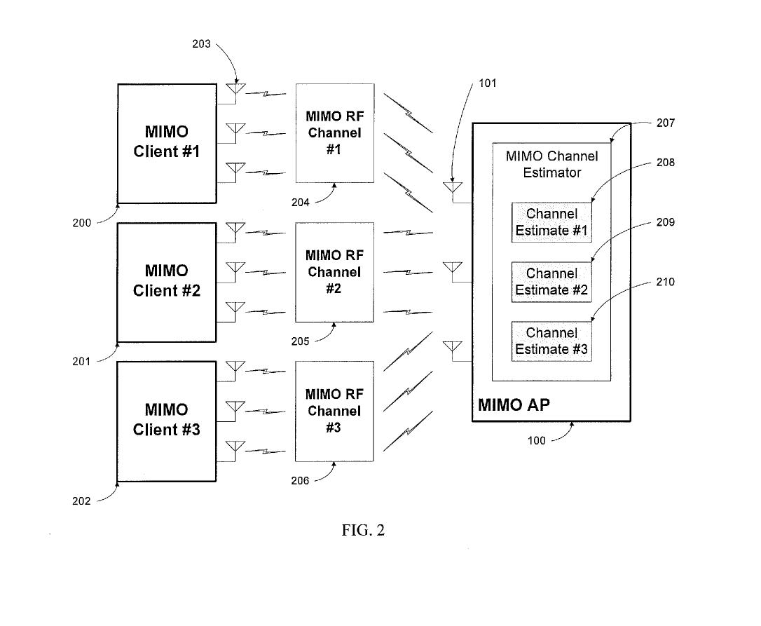

Turning now to FIG. 2, a single MIMO AP 100 is depicted as being in communication with multiple MIMO clients 200, 201, 202. It will be appreciated that this is the obverse of the situation depicted in FIG. 1, and it will also be noted that a typical client such as an IEEE 802.11 client may communicate with a single AP, whereas an AP such as an IEEE 802.11 AP may communicate with multiple clients. In addition, it should be understood that while FIG. 2 depicts three clients 200, 201, 202 and three RF channels 204, 205, 206, in actual practice any desired number of clients may be communicating with AP 100 over any other desired number of RF channels; it is also possible for more than one client to share the same RF channel, as for example in situations where two or more clients are physically located in close proximity. The discussion herein should therefore be taken as applying to an arbitrary number of clients communicating over another arbitrary number of RF channels.

In FIG. 2, each client 200, 201, 202 may communicate with AP 100 through a different RF channel 204, 205, 206. For successful reception of MIMO RF signals from individual clients, channel estimator 207 in AP 100 may have to calculate separate channel estimates 208, 209, 210 corresponding to the different RF channels 204, 205, 206 respectively. Further, AP 100 may need to utilize the correct one out of the possible set of channel estimates 208, 209, 210 when receiving a packet from a specific client; as an example, it may need to utilize channel estimate 208 that may correspond to RF channel 204 when receiving packets from client 200, but alternatively may need to utilize channel estimate 210 which may correspond to RF channel 206 when receiving packets from client 202. Utilizing the wrong channel estimate may result in the received signals being decoded with high bit error ratios, or not being decoded at all. Further, using the correct channel estimate corresponding to the actual RF channel traversed by a received packet may be essential when attempting to refine the channel estimate or equalization matrix using data from multiple packets, as combining channel estimates from different channels may result in substantial errors. Finally, it may be necessary to rapidly identify, select and retrieve the correct one of several stored channel estimates when attempting to receive a packet or refine an existing channel estimate or equalization matrix.

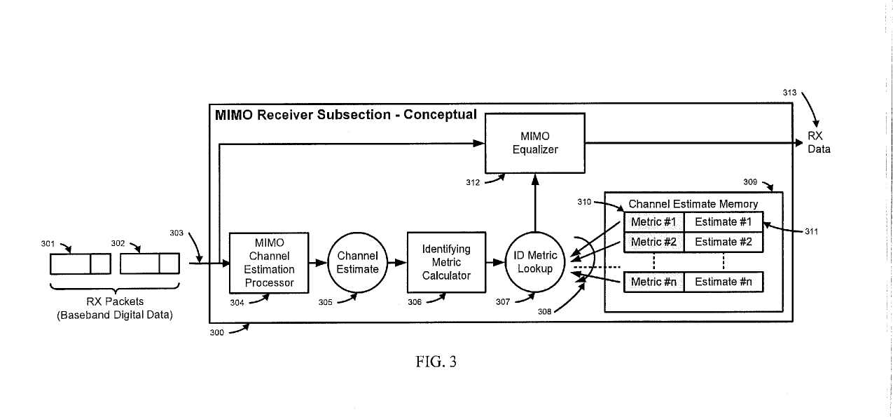

An illustrative conceptual representation of a portion of an iterative wireless channel estimation setup according to an embodiment of the subject matter described herein is depicted in FIG. 3, which may comprise: MIMO receiver subsection 300 which may receive packetized digital data 301, 302 on input 303. The digital data may be baseband digital data, which may further include packet header and payload delimiters that may identify individual received packets, may be processed by MIMO channel estimation processor 304 that may implement a conventional MIMO channel estimation algorithm, one possible example being zero-forcing estimation. The output of channel estimation processor 304 may be a channel estimate 305 that may be passed to identifying metric calculator 306, which may derive some form of metric pertaining to the channel estimate just generated. The identifying metric may be selected in such a way that different channel estimates may be distinguished from each other by comparing their metrics. The identifying metric may be passed to ID metric lookup 307 which may utilize it to perform a search 308 of channel estimate memory 309.

Channel estimate memory 309 may hold some number of channel estimates 311, depicted for representational purposes as Estimate #1 through Estimate #n. Each one of estimates 311 may be associated with a separate stored metric 310, correspondingly depicted for representational purposes as Metric #1 through Metric #n. ID metric lookup 307 may search through the set of stored metrics 310 until it finds one that most closely matches the newly calculated metric that may be supplied from identifying metric calculator 306. If such a match is found, ID metric lookup 307 may retrieve the corresponding channel estimate from channel estimate memory 309 and pass either or both of the newly calculated channel estimate 305 and the looked-up stored channel estimate 311 to MIMO equalizer 312. Equalizer 312 may also receive a copy of baseband digital data, and may use the channel estimate or estimates provided by ID metric lookup 307 to perform an equalization process on the baseband data to compensate for the effects of the RF channel and recover receive data 313. This receive data may then be passed to the remainder of the system for processing, which may include MIMO space-time demultiplexing, channel decoding, and frame processing.

It should be noted that FIG. 3 may depict only the essential elements relating to channel estimation, calculation of equalization coefficients, and signal equalization, and may omit other key elements of a complete digital wireless MIMO receiver. As such, FIG. 3 is provided as a conceptual presentation only.

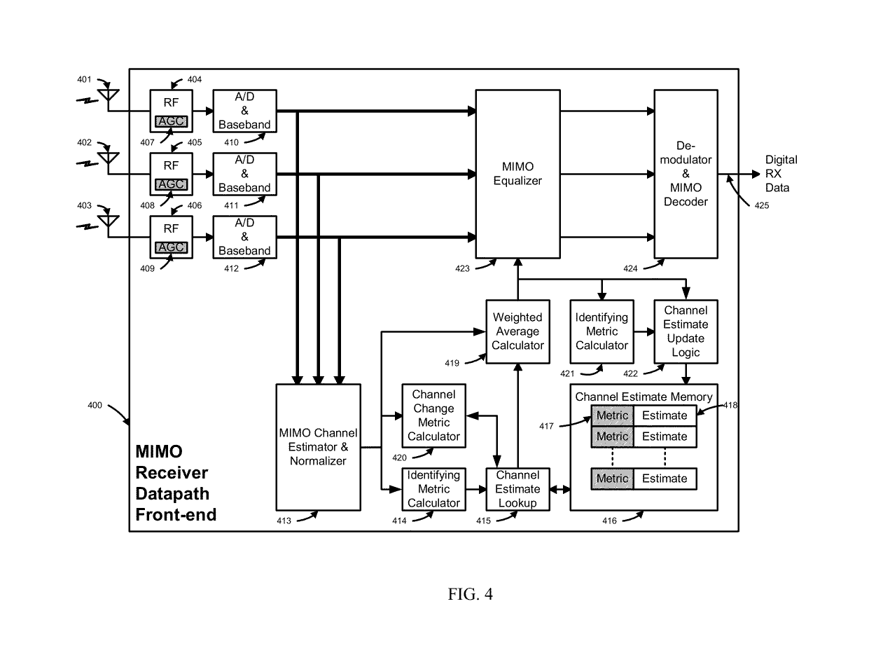

With reference to FIG. 4, an embodiment of an iterative wireless channel estimation system that may be suitable for communications protocols such as IEEE 802.11 is shown. As depicted, the embodiment may utilize wireless antennas 401, 402, 403 to receive transmitted RF signals and pass them to RF chains 404, 405, 406, which may contain elements such as Automatic Gain Control (AGC) amplifiers 407, 408, 409. Amplified and down-converted RF signals may then be provided to analog-to-digital converters (ADCs) and baseband processors 410, 411, 412, which may perform suitable digitization and pre-processing functions such as filtering, digital down conversion, channel carrier assessment (CCA), and packet boundary detection.

Digitized RF data may then be supplied to MIMO channel estimator and normalizer 413, which may utilize a suitable MIMO channel estimation algorithm to determine the coefficients of the RF wireless channel, and may further compensate for the amplitude and phase changes that may, for example, be introduced by the effects of the AGC amplifiers, by normalizing the estimated channel matrix. (It should be appreciated that channel estimator 413 may calculate a channel equalization matrix directly, rather than calculating a channel matrix and then further calculating a channel equalization matrix from it, as the equalization matrix may be linearly derived from the channel matrix.) The output of channel estimator 413 may be fed to identifying metric calculator 414, which may compute a suitable identifying metric associated with the channel matrix (or equalization matrix) generated by channel estimator 413. Calculated identifying metrics may be provided to channel estimate lookup unit 415, which may utilize them to search channel estimate memory 416. Channel estimate memory 416 may contain one or more channel estimates 418 that may be stored in association with one or more previously calculated identifying metrics 417; a newly calculated identifying metric generated by identifying metric calculator 414 may be compared to stored identifying metrics 417 by lookup unit 415.

If the comparison succeeds, lookup unit 415 may retrieve one or more corresponding associated channel estimate(s) 418 and may provide this data to channel change metric calculator 420. Channel change metric calculator 420 may further be supplied with the newly calculated channel estimate from channel estimator 413, and may compare it to the stored channel estimate(s) retrieved by lookup unit 415. If a stored estimate is sufficiently close to the newly calculated estimate, as may be determined by a pre-set threshold imposed upon the calculated channel change metric, lookup unit 415 may further supply the corresponding stored channel estimate to weighted average calculator 419. Weighted average calculator 419 may also receive the newly determined channel estimate for the received data from channel estimator 413, and may combine these two channel estimates according to some predetermined weighting function, and may output a new composite channel estimate to MIMO equalizer 423. Equalizer 423 may then use this composite channel estimate to process baseband signals supplied from baseband processors 410, 411, 412 to reverse the effects of the RF channel upon the signals received at antennas 401, 402, 403, and then may supply processed signals to demodulator and MIMO decoder 424. Demodulator and decoder 424 may finally perform a receive demodulation and space-time demultiplexing function to regenerate digital receive data 425.

Weighted average calculator 419 may further supply a composite channel estimate to a second identifying metric calculator 421 and may also supply a composite channel estimate to channel estimate update logic 422. Channel estimate update logic 422 may accept both the composite channel estimate as well as the new identifying metric calculated by identifying metric calculator 421 and may store this data in channel estimate memory 416. It should be noted that channel estimate update logic 422 may overwrite an existing value of channel estimate 418 and identifying metric 417, or may add the former data as new values of channel estimate 418 and identifying metric 417, depending on whether the existing value may be expected to be used for future reception or whether it may be discarded.

If channel change metric calculator 420 determines that the stored channel estimate is not sufficiently close to the new estimate calculated by channel estimator 413, it may notify channel estimate lookup 415, which may then discard the channel estimate read from channel estimate memory 416 and instead supply the new estimate directly to weighted average calculator 419. At this point no weighting may be performed, and weighted average calculator 419 may supply the new estimate unchanged to equalizer 423, second identifying metric calculator 421, and channel estimate update logic 422. This may prevent the introduction of errors and spurious equalization coefficients when the current RF channel as seen from antennas 401, 402, 403 has diverged significantly from the previously calculated RF channel.

It should be appreciated that the elements outlined in FIG. 4 are for explanatory purposes, and different aspects and arrangements of some or all of the various functions depicted are possible. For example identifying metric calculator 414 and second identifying metric calculator 421 may perform the same calculation (though on different data) and therefore may be combined into one unit, wherein the combined unit first calculates an identifying metric from data provided by channel estimator 413 and subsequently calculates an identifying metric from data provided by weighted average calculator 419. As another example, channel estimator 413 may directly compute a channel equalization matrix (as noted previously), in which case the data stored in channel estimate memory as channel estimates 418 may actually represent equalization matrices. Channel change metric calculator 420 and weighted average calculator 419, as well as MIMO equalizer 423, may then utilize these equalization matrices directly. As yet another example, the number of stored channel estimates 418 and associated identifying metrics 417 in channel estimate memory 416 may vary depending on the situation; for instance, in the case of a wireless LAN client device that may communicate exclusively with a single wireless LAN access point device, it may be efficient to store only one channel estimate 418 and identifying metric 417, while in the opposite case it may be more effective to store multiple such entries.

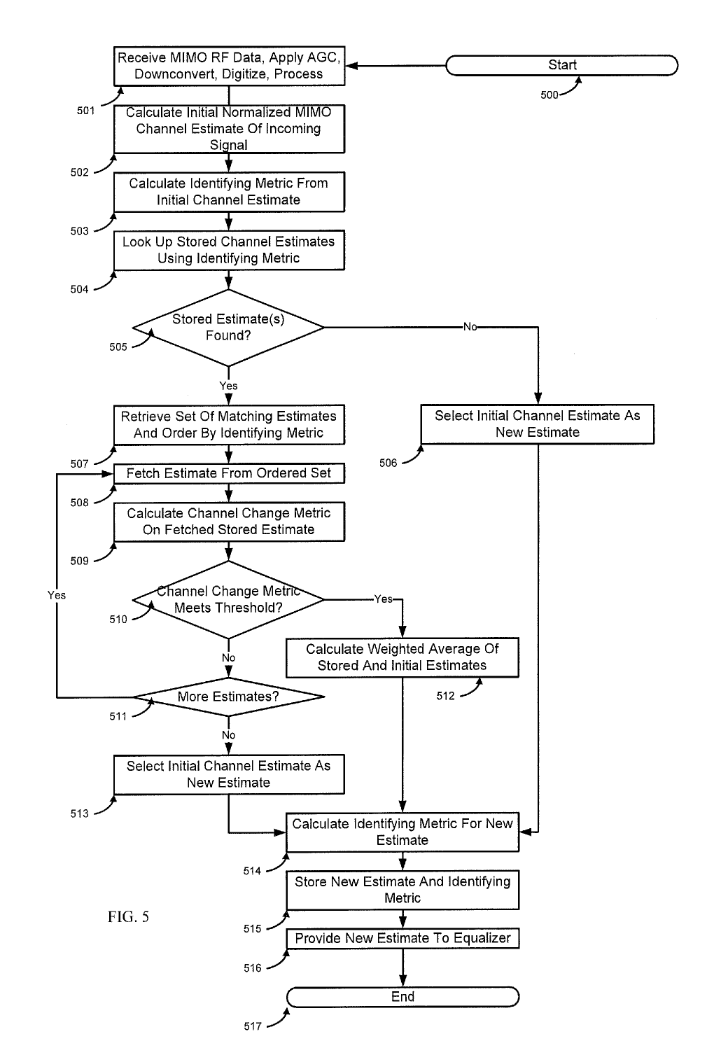

In accordance with an aspect of an iterative channel estimation method, FIG. 5 depicts an exemplary flowchart for computing new channel estimates from one frame of received data, selecting a stored channel estimate, calculating a possibly improved channel estimate, and storing the improved channel estimate or updating the stored channel estimate if necessary. It should be appreciated that the procedure may apply equally to the calculation of equalization matrices in place of or in addition to channel estimates. The procedure may include the steps of:
a) At step 500, beginning the procedure, possibly upon the commencement of reception of a packet;
b) At step 501, receiving MIMO RF signal data, applying AGC to control signal amplitude, down-converting, digitizing, and performing digital signal processing at the baseband or low Intermediate Frequency (IF) level;
c) At step 502, calculating an initial MIMO channel estimate (or equalization matrix) for the incoming signal and normalizing it, for example using pilot signals or preamble training sequences;
d) At step 503, calculating an identifying metric for the initial channel estimate;
e) At step 504, using the identifying metric to look up one or more channel estimate(s) from a set of one or more stored channel estimates;
f) At step 505, determining whether one or more stored estimates have been found, possibly by checking whether the match between the stored identifying metric(s) and the newly calculated identifying metric is within a certain threshold;
g) At step 506, if no stored estimates have been found, selecting the initial channel estimate as the new estimate to use during processing, and proceeding directly to step 514;
h) At step 507, if one or more stored estimates have been found, retrieving these matching estimates, and possibly ordering them by the degree of match between their corresponding identifying metrics and the newly calculated identifying metric;
i) At step 508, fetching an estimate from the ordered set;
j) At step 509, calculating a channel change metric on the estimate fetched in step 508;
k) At step 510, determining if the channel change metric meets a predetermined threshold;
l) At step 511, if the channel change metric does not meet the predetermined threshold, checking if more estimates remain to be fetched from the ordered set, and, if so, returning to step 508 to fetch the next estimate and repeat the process;
m) At step 512, if the channel change metric meets the predetermined threshold, selecting the corresponding stored channel estimate, and calculating the weighted average of the stored and initial channel estimates as the new estimate;
n) At step 513, if no more estimates remain to be fetched from the ordered set, selecting the initial channel estimate as the new estimate;
o) At step 514, calculating an identifying metric for the new estimate;
p) At step 515, storing the new estimate and the identifying metric for future use;
q) At step 516, providing the new estimate to the MIMO equalizer for use in recovering received digital data; and
r) At step 517, terminating the procedure.

Ordering (sorting) the retrieved channel estimates according to their identifying metrics in step 507 may speed up the subsequent searching process by allowing estimates that are more likely to match to be checked first; these estimates are correspondingly more likely to have identifying metrics closer to that of the initial channel estimate.

Normalization of the channel estimate (or equalization matrix) may be performed using a number of mathematical matrix operations that are well known in the art. One possible method of normalizing the channel estimate matrix may be to divide all coefficients in the matrix by the reciprocal of the Frobenius norm of the matrix, multiplied by the square root of the number of receive antennas, as represented in the following calculation:

Hⁿ=(√(N)/∥H∥_{Frobenius})*H

where Hⁿ may represent the normalized channel estimate, ∥H∥_{Frobenius} may be the Frobenius norm of the channel estimate matrix H, and Nᵣ may stand for the number of receive antennas.

A suitable channel change metric may represent the difference between the initial and stored channel estimate matrices, each matrix being a set of complex valued coefficients. Ideally, the calculation of the channel change metric may be selected such that it is simple to perform in digital signal processing hardware and at the same time the value of the channel change metric increases as the Euclidean distance between the two channel estimates being compared increases. One possible channel change metric may be calculated from the sum of the absolute differences between the initial and stored channel estimates, further summed over all the subcarriers contained within the signal, further summed over all the parallel receive chains, further summed over all the parallel transmit chains, as represented in the following calculation:

M_{change}=Σ_{Nt}Σ_{Nr}Σ_{sc}|Hᵢₙᵢₜᵢₐₗⁿ−H_{stored}ⁿ|

where M_{change} may represent the channel change metric, Σ_{Nt} may represent summation over the transmit chains (i.e., the columns of the matrix), Σ_{Nr} may represent summation over the receive chains (i.e., the rows of the matrix), Σ_{sc} may represent summation over all subcarriers, Hᵢₙᵢₜᵢₐₗⁿ may be the normalized initial channel estimate, and H_{stored}ⁿ may be the normalized stored channel estimate.

The absolute weighted difference as calculated by the foregoing may change only slightly due to differences in noise levels of two nearly identical channels, but may change much more significantly if the channel itself changes. A predetermined threshold may therefore be calculated, possibly in an empirical manner, and may be applied to the channel change metric to distinguish between channels that are widely varying. If a channel has been determined to be substantially different from the initial channel estimate, it may be discarded or eliminated from consideration.

The identifying metric may be calculated and utilized in order to speed up the process of locating and comparing channel estimates. The calculation of the channel changed metric may be computationally fairly intensive, as it may entail operations performed on every matrix coefficient for all matrices representing subcarriers. A suitable identifying metric, however, may consist of a single complex number that need not necessarily correspond to any mathematical property of the matrix, but may differ from identifying metrics calculated on other channel estimate matrices in proportion to the Euclidean distance between them. It may therefore be significantly faster and simpler to compare the identifying metrics of two channel estimate matrices to determine if they are sufficiently similar, rather than calculating the entire channel change metric. Further, it may be useful to order the matrices so selected according to the difference between their identifying metrics and that of the initial channel estimate, which may thereby optimize and speed up the process of searching them.

One possible identifying metric for a channel estimate matrix may be a matrix norm, such as a Frobenius norm. However, the calculation of the Frobenius norm may be relatively computationally intensive; also, being an absolute measure, the Frobenius norm may neglect the effects of the angular components of the channel estimate coefficients. Another possible identifying metric may be the weighted vector sum of all of the coefficients of a normalized channel estimate matrix, which may be computationally simpler to calculate, and may factor in both the phase and amplitude of the complex coefficients. The weighted vector sum identifying metric may be calculated as a dot product of a weighting matrix and the channel estimate matrix as follows:

M_{ID}=Σ(wᵢⱼ*aᵢⱼ)

where M_{ID} may represent the identifying metric, wᵢⱼ may be a complex weight applied to the matrix coefficient at the i^{th} column and j^{th} row, and aᵢⱼ may be the matrix coefficient at that row and column. The weights wᵢⱼ may be useful to avoid the possibility that two channel estimate matrices that may differ by two coefficients aᵢⱼ and a′ᵢⱼ that are similar in value but placed in different location may yield the same identifying metric. The weights assigned may be simple, such as (1, −1), (−1, 1), (1, 0.5), . . . which may be easily realizable in binary arithmetic. In multi-carrier situations such as OFDM, an identifying metric may be calculated separately for the channel estimate or equalization matrix for each subcarrier taken individually, or a composite identifying metric may be calculated for a set of subcarriers by weighting and summing the individual identifying metrics for each subcarrier. Calculating separate identifying metrics for individual subcarriers may be beneficial when estimation and equalization is performed on a per-subcarrier basis. Calculating a single composite identifying metric for multiple subcarriers may be beneficial when channel estimates or equalization matrices for all subcarriers are calculated and stored together as a block.

Generation of a new normalized channel estimate may be performed using a weighted averaging process, which may cause newer and more accurate estimates to contribute a higher weighting than older estimates. Calculation of a new channel estimate may take the form of a weighted moving average computed over the complex channel estimate matrices, as follows:

H_{new}ⁿ(n)=G*Hᵢₙᵢₜᵢₐₗⁿ+(1−G)*H_{new}ⁿ(n−1)

where H_{new}ⁿ(n) may represent the new normalized channel estimate at the end of step n, G may represent the complex weighting gain matrix, Hᵢₙᵢₜᵢₐₗⁿ may represent the initial normalized channel estimate calculated over the received data, and H_{new}ⁿ(n−1) may represent the normalized weighted-average channel estimate calculated at the end of step (n−1) (i.e., at the beginning of step n). G may contain scalar values in the range of 0 to 1, and may be selected as approximately 0.4.

It will be apparent to those of ordinary skill in the art that the embodiments and aspects described herein may be applicable to a number of wireless technologies, such as OFDM and multi-user MIMO (MU-MIMO), as well as a number of wireless communications protocols, such as the IEEE 802.11 and Long Term Evolution (LTE) protocols. In the case of IEEE 802.11, the STF/LTF training sequences may provide the initial channel estimates, and the frame data symbols may be further used to update and improve these channel estimates. In the case of LTE, the primary and secondary synchronization sequences (PSS and SSS, respectively) may provide the initial channel estimates, the reference symbols may provide similar functions as 802.11 pilot symbols, and the data symbols may be used to update and improve the channel estimates. As discussed in co-pending U.S. patent application Ser. No. 61/900,973, the use of frame data symbols to improve channel estimates is dependent on the accurate reconstruction of the binary data represented within these frame data symbols. Additionally, for short data frames (i.e., frames that may contain only a small number of symbols), there may not be enough frame data symbols to provide a sufficient improvement of the channel estimates. The aspects discussed herein may allow a more accurate reconstruction of the binary data from the frame data symbols by using a more accurate new channel estimate derived from multiple frames, and may also permit the derivation of a more accurate channel estimate for short data frames. As such, these embodiments and aspects may provide methods of achieving substantially improved channel estimation and equalization without significant additional complexity. Advantageously, this may permit reduced cost and complexity of implementing wireless technologies that may be constrained by the accuracy of channel estimation.

It will be appreciated that, in accordance with embodiments described herein, the selection, retrieval and comparison of channel estimates or the corresponding equalization matrices may be greatly improved by including an identifying metric calculated over the channel estimate matrices in the selection and comparison process. Further, sorting a set of selected channel matrices according to their identifying metrics relative to the identifying metric of the initial estimate may enable the correct channel matrix to be found earlier in the search. Advantageously, this may significantly improve the efficiency of the system, reduce the time required to obtain the final channel estimate, and reduce the amount of hardware required to perform the calculations.

It will further be appreciated that it is not necessary to include all of the subcarriers in the calculation of the identifying metric. For example, if there are 52 active subcarriers (as in the case of IEEE 802.11 wireless LAN), it may be sufficient to calculate a composite identifying metric over no more than 8 of the subcarriers, distributed uniformly over the frequency band of interest. This may be possible if the wireless channel is reasonably frequency-flat and the RF channel statistics are not significantly variant over the occupied bandwidth. Advantageously, this may reduce the complexity of the calculations and the amount of hardware required to perform them.

It will yet further be appreciated that the use of a channel change metric may allow the wireless receiver to quickly determine when a particular RF channel has changed to the extent that previously calculated channel estimates are no longer usable, for example if the wireless transmitter has changed position or orientation. In addition, the use of a channel change metric may enable the wireless receiver to deal with multiple clients that are nearly co-located (as for instance in a high-density environment), so that the channel estimate calculated over packets received from one client might be usable to improve the channel estimate for packets received from another client. This may be possible because the channel change metric is an absolute measure of the difference between two RF channel estimates and hence may be used to simplify the task of determining whether or not to incorporate a given channel estimate (or equalization matrix) in the calculation of the weighted average. Advantageously, this may improve the efficiency of the wireless system, reduce the number of channel estimates that may need to be stored, and reduce the amount of calculations that may need to be performed for each received packet.

Accordingly, while the subject matter herein has been described with reference to illustrative embodiments, this description is not intended to be construed in a limiting sense. Various modifications of the illustrative embodiments, as well as other aspects or embodiments of the subject matter described herein, will be apparent to persons of ordinary skill in the art upon reference to this description. These modifications shall not be construed as departing from the scope of the subject matter described herein, which is defined solely by the claims appended hereto.

1. A system for calculating radio frequency (RF) wireless channel properties for digital communications over a wireless channel, comprising:
a receive processor for receiving information over said wireless channel, converting the information to digital signals, and processing the digital signals;
a channel estimator for calculating a first channel property matrix from said digital signals;
a storage unit containing a plurality of previously computed channel property matrices;
a storage lookup unit operatively coupled to said storage unit that selects at least one second channel property matrix from said plurality of previously computed channel property matrices;
a function for determining whether said first channel property matrix is usable with said at least one second channel property matrix or said at least one second channel property matrix is usable with said first channel property matrix;
a combination unit for generating a composite channel estimate based on said first and said at least one second channel property matrix; and
an equalizer for using the composite channel estimate to process baseband signals supplied from a plurality of baseband processors to reverse effects of the wireless channel on signals carrying the information over the wireless channel.

2. The system of claim 1, wherein said function comprises a channel change calculator function for computing a difference between said first and said at least one second channel property matrices, and further wherein said difference computed by said channel change calculator function is operative to determine if said at least one second channel property matrix is usable with said first channel property matrix.

3. The system of claim 1, wherein said first and said at least one second channel property matrices are wireless channel estimates.

4. The system of claim 1, wherein said first and said at least one second channel property matrices are channel equalization matrices.

5. The system of claim 1, wherein said first channel property matrix is normalized to compensate for amplitude variations.

6. The system of claim 1, wherein said channel change calculator function calculates a channel change metric.

7. (canceled)

8. The system of claim 1, wherein said composite channel estimate is a weighted average of said first and said at least one second channel property matrix.

9. (canceled)

10. The system of claim 1, wherein said plurality of previously computed channel property matrices is calculated from previously received digital data.

11. The system of claim 1, further including a storage update unit operatively coupled to said storage unit that updates said plurality of previously computed channel property matrices from the output of said channel property matrix combination unit.

12. The system of claim 1, wherein said function comprises: a first identifying metric calculator function for computing a first identifying metric on said first channel property matrix, wherein said at least one second channel property matrix comprises a plurality of second candidate channel property matrices, and wherein said first identifying metric is operative to determine if said first channel property matrix is usable with at least one of said plurality of candidate channel property matrices.

13. The system of claim 1, wherein said at least one second channel property matrix comprises a plurality of candidate channel property matrices, and wherein said function comprises: a selector function for successively selecting one of said plurality of candidate channel property matrices as a selected channel property matrix, and a channel change calculator function for computing a difference between said first channel property matrix and said selected channel property matrix, wherein said difference computed by said channel change calculator function is operative to determine if said selected channel property matrix is usable with said first channel property matrix.

14. A method of calculating a property matrix for a radio frequency (RF) wireless channel, the method comprising the steps of:
receiving RF signals;
converting said RF signals to digital signals;
processing said digital signals;
calculating a first channel property matrix from said digital signals;
retrieving a second channel property matrix from a storage medium;
determining whether said first channel property matrix is usable with said at least one second channel property matrix or said at least one second channel property matrix is usable with said first channel property matrix;
generating, by a combination unit, a composite channel estimate based on said first and said at least one second channel property matrix; and
using, by an equalizer, the composite channel estimate to process baseband signals supplied from a plurality of baseband processors to reverse effects of the wireless channel on signals carrying the information over the wireless channel.

15. The method of claim 14, wherein determining whether said at least one second channel property matrix is usable with said first channel property matrix comprises calculating a channel change metric using said first and said at least one second channel property matrices, wherein said channel change metric is used to determine if said at least one second channel property matrix is usable in conjunction with said first channel property matrix.

16. The method of claim 14, wherein said first and said at least one second channel property matrices are calculated using RF channel estimation.

17. The method of claim 14, wherein said first and said at least one second channel property matrices are calculated using RF channel equalization.

18. The method of claim 14, further including the step of normalizing said first channel property matrix.

19. The method of claim 14, further including the step of linearly combining said first and said at least one second channel property matrices.

20. The method of claim 19, wherein said linear combination is performed by calculating a weighted average of said first and said at least one second channel property matrices.

21. The method of claim 14, wherein determining whether said first channel property matrix is usable with said at least one second channel property matrix comprises:
calculating a first identifying metric from said first channel property matrix; and
retrieving said at least one second channel property matrix from a storage medium containing a plurality of stored channel property matrices,
wherein said first identifying metric is used to select said at least one second channel property matrix from said plurality of stored channel property matrices.

22. The method of claim 14, wherein determining whether said at least one second channel property matrix is usable with said first channel property matrix comprises:
calculating a first identifying metric from said first channel property matrix;
retrieving a plurality of channel property matrices using said first identifying matrix;
successively selecting at least one candidate channel property matrix from said plurality of retrieved channel property matrices;
calculating a channel change metric using said first channel property matrix and said at least one candidate channel property matrix; and
using said channel change metric to check if said candidate channel property matrix is usable in conjunction with said first channel property matrix,
wherein said candidate channel property matrix is assigned as said at least one second channel property matrix according to said check.
